(19) United States
(12) Patent Application Publication
(10) Pub. No.: US 2012/0188552 A1
(43) Pub. Date: Jul. 26, 2012

(54) VARIABLE WAVELENGTH INTERFERENCE FILTER, OPTICAL MODULE, SPECTROSCOPIC ANALYZER, AND ANALYZER

(75) Inventor: Nozomu HIROKUBO, Fujimi (JP)

(73) Assignee: SEIKO EPSON CORPORATION, Tokyo (JP)

(21) Appl. No.: 13/353,583

(22) Filed: Jan. 19, 2012

(30) Foreign Application Priority Data
Jan. 20, 2011 (JP) 2011-010062

(51) Int. Cl. G01J 3/45; G02B 5/28; G01B 9/02

(52) U.S. Cl. 356/451; 356/450; 359/589

(57) ABSTRACT

A variable wavelength interference filter includes a fixed substrate having a fixed reflecting film, a movable substrate having a movable reflecting film, and an electrostatic actuator including a fixed electrode and a movable electrode. The fixed electrode includes first and second fixed partial electrodes electrically isolated from each other. First and second extraction electrodes extending from the first and second fixed partial electrodes, respectively, are formed on the fixed substrate. The movable electrode is formed in a ring shape covering first and second facing regions facing the first and second fixed partial electrodes, respectively.

### BACKGROUND

1. Technical Field

The present invention relates to a variable wavelength interference filter that acquires light of a specific wavelength, an optical module, and a spectroscopic analyzer.

2. Related Art

In the related art, a variable wavelength interference filter (optical filter device) that extracts light of a specific wavelength from light having a plurality of wavelengths is known (for example, see JP-A-2009-251105).

The variable wavelength interference filter (optical filter device) disclosed in JP-A-2009-251105 includes a first substrate which has a movable portion (first portion) and a diaphragm (second portion) supporting the movable portion, and a second substrate that faces the first substrate. Moreover, a movable mirror is formed in the movable portion of the first substrate, and a fixed mirror is formed on a surface of the second substrate facing the movable portion. A ring-shaped electrode is formed on each of the first and second substrates, and an extraction wiring is formed so as to extend from these electrodes to the outer periphery of each of the substrates.

In the variable wavelength interference filter disclosed in JP-A-2009-251105, however, the extraction wiring formed on the first substrate faces the second substrate, and the extraction wiring formed on the second substrate faces the first substrate. In such a configuration, when connecting the wirings while incorporating the variable wavelength interference filter into a module such as a sensor, it is necessary to perform a wiring operation on the extraction wirings formed on different substrates. This operation is complicated.

In contrast, a variable wavelength interference filter in which wirings for applying a voltage are laid out to only one substrate by forming a floating electrode on one substrate is known (for example, see JP-A-11-167076).

JP-A-11-167076 shows a variable wavelength interference filter (interferometer) having a configuration in which one rectangular floating electrode is provided to a movable mirror (first mirror), and two control electrodes are provided to a fixed mirror (second mirror). In such a variable wavelength interference filter, it is possible to apply a voltage between the control electrodes and the floating electrode by laying out wirings to a pair of control electrodes provided on one substrate. Thus, it is possible to displace the movable mirror by an electrostatic attractive force.

In the variable wavelength interference filter of JP-A-11-167076, however, a rectangular floating electrode is formed at the movable mirror. In such a configuration, the electrostatic attractive force acting in the circumferential direction about the center of a light transmitting portion becomes uneven. For example, in a straight line region extending from the center of the light transmitting portion to the apexes of the rectangle of the floating electrode, the length facing the control electrode is large, and a great electrostatic attractive force acts on the straight line region. On the other hand, in a straight line region extending from the center of the light transmitting portion to the midpoint of the sides of the rectangle of the floating electrode, the length facing the control electrode is small, and the electrostatic attractive force decreases. That is, looking into the balance of the electrostatic attractive force in the circumferential direction about the central point of the light transmitting portion, the electrostatic attractive force in a region extending from the center of the light transmitting portion to the apexes of the rectangle is large, and the electrostatic attractive force in the other regions is small. Thus, the electrostatic attractive force is uneven.

Moreover, the electrostatic attractive force becomes stronger as the inter-electrode distance decreases. Thus, as the applied voltage increases, the difference between the electrostatic attractive force acting in the straight line region extending from the center of the light transmitting portion to the apexes of the rectangle of the floating electrode and the electrostatic attractive force acting in the straight line region extending from the center of the light transmitting portion to the midpoints of the sides of the rectangle of the floating electrode increases. Thus, the movable mirror may be deformed. In this case, the resolution of the variable wavelength interference filter may decrease.

### SUMMARY

An advantage of some aspects of the invention is that it provides a variable wavelength interference filter having a simple structure capable of suppressing a decrease of resolution even when the gap dimension between reflecting films is changed and capable of making the connection of wirings easy, an optical module and a spectroscopic analyzer each including the variable wavelength interference filter.

An aspect of the invention is directed to a variable wavelength interference filter including a first substrate; a second substrate facing the first substrate; a first reflecting film formed on the first substrate; a second reflecting film formed on the second substrate so as to face the first reflecting film with a gap therebetween; and an electrostatic actuator including a first electrode formed on the first substrate and a second electrode formed on the second substrate so as to face the first electrode, wherein the second substrate is formed in a circular shape in a plan view of the first and second substrates viewed from a substrate thickness direction, and includes a movable portion on which the second reflecting film is formed and a holding portion that holds the movable portion so as to be movable toward and away from the first substrate, wherein the first electrode includes a first partial electrode and a second partial electrode which are formed along an imaginary circle having a center at a central point of the movable portion in the plan view, wherein a first extraction electrode extending from the first partial electrode toward an outer circumference of the first substrate and a second extraction electrode extending from the second partial electrode toward the outer circumference of the first substrate are formed on the first substrate, wherein the second electrode includes a first facing region overlapping the first partial electrode and a second facing region overlapping the second partial electrode in the plan view and has a ring shape having a center at the central point of the movable portion, wherein a first partial actuator made up of the first partial electrode and the first facing region of the second electrode has a uniform width dimension along the imaginary circle in the plan view, and wherein a second partial actuator made up of the second partial electrode and the second facing region of the second electrode has a uniform width dimension along the imaginary circle in the plan view.

In the above aspect of the invention, the first electrode formed on the first substrate includes the first and second partial electrodes electrically isolated from each other, and the first and second extraction electrodes are connected to the first and second partial electrodes, respectively. Moreover, the second electrode formed on the second substrate includes the first facing region facing the first partial electrode and the second facing region facing the second partial electrode and is formed in an annular shape.

In such a configuration, when a voltage is applied between the first and second extraction electrodes, a voltage is applied between the first partial electrode and the first facing region of the second electrode and between the second partial electrode and the second facing region of the second electrode. As a result, at least one of the first and second substrates can be deformed toward the other substrate by an electrostatic attractive force generated between these electrodes. Thus, it is possible to change the gap dimension between the first and second reflecting films.

Since the first and second extraction electrodes are formed on the first substrate, even when incorporating the variable wavelength interference filter into an optical module such as a sensor body, it is only necessary to perform a wiring operation on the respective extraction electrodes formed on the first substrate. Thus, the operation efficiency can be improved.

Moreover, when extraction electrodes are formed on both the first and second substrates, and a wiring operation is performed on these extraction electrodes in a state where the first substrate is fixed to a fixing portion of the optical module, stress may be applied in a direction of separating the second substrate from the first substrate when connecting wirings to the extraction electrode of the second substrate. In this case, the first and second substrates may be detached, and the substrates may be deformed by stress so that the gap between the reflecting films may be changed. When wirings are laid out with a small force in order to prevent detachment or deformation of the substrates, the wiring reliability may decrease.

In contrast, in the present embodiment, since the first and second extraction electrodes are formed in only the first substrate, when a wiring operation is performed with the first substrate fixed to the fixing portion of the optical module, for example, no stress should be applied to the second substrate. As a result, problems such as detachment or deformation of substrates can be prevented, and sufficient wiring reliability can be obtained.

Moreover, the first partial actuator made up of the first partial electrode and the first facing region of the second electrode and the second partial actuator made up of the second partial electrode and the second facing region of the second electrode have a uniform width dimension along the circumferential direction of the imaginary circle. Thus, the electrostatic attractive force should not become uneven along the circumferential direction. Therefore, it is possible to prevent tilting or deformation of the movable portion due to unevenness of the electrostatic attractive force when the movable portion is displaced and to maintain resolution of the variable wavelength interference filter with high accuracy.

Furthermore, since the second electrode is formed in an annular shape having the center at the central point of the movable portion, the influence on the holding portion, of the film stress of the second electrode becomes uniform along the circumferential direction. Thus, it is possible to prevent deformation of the holding portion and tilting of the movable portion due to the film stress of the second electrode.

In the variable wavelength interference filter of the above aspect of the invention, it is preferable that the first partial electrode has an annular shape along a first imaginary circle, and the second partial electrode has a circular arc shape along a second imaginary circle having a larger diameter than the first imaginary circle.

In this configuration, the first electrode includes the first partial electrode having a ring shape along the first imaginary circle and the second partial electrode having a circular arc shape along the second imaginary circle. Here, the second partial electrode is formed in a circular arc shape in order to pull out the first extraction electrode, and more preferably, is formed in a C-shape of which the ends are open so that the first extraction electrode can pass therethrough.

In this configuration, the electrostatic attractive force generated in the first partial actuator can be made uniform over the entire circumference of the first imaginary circle, and unevenness of the electrostatic attractive force can be prevented more reliably. Moreover, the electrostatic attractive force generated in the second partial actuator can be made uniform over approximately the entire circumference, and unevenness of the electrostatic attractive force can be prevented.

Therefore, deformation or tilting of the movable portion due to unevenness of the electrostatic attractive force can be prevented more reliably.

In the variable wavelength interference filter of the above aspect of the invention, it is preferable that the first partial electrode has a circular arc shape along a first imaginary circle, and the second partial electrode has a circular arc shape along the first imaginary circle and is formed in the same shape as the first partial electrode in the plan view, and the first and second partial electrodes are formed at positions symmetrical about the central point of the movable portion.

In this configuration, the first and second partial electrodes are formed at positions in a point-symmetrical relation along the same first imaginary circle. In such a configuration, the electrostatic attractive forces generated in the first and second partial actuators can be made to be the same. Therefore, for example, in the initial state, even when the holding portion has a tilt that does not affect the measurement accuracy, and the inter-electrode gap is different from the first partial actuator and the second partial actuator, it is possible to move the movable portion toward the first substrate side in parallel without increasing the difference.

Another aspect of the invention is directed to an optical module including the variable wavelength interference filter according to the above aspect and a detector that detects light extracted by the variable wavelength interference filter.

In the above aspect of the invention, the optical module includes the variable wavelength interference filter according to the above aspect. As described above, the variable wavelength interference filter enables a wiring operation to be performed easily when incorporating the same into the optical module, and wiring reliability can be improved. Therefore, in the optical module, it is possible to easily incorporate the variable wavelength interference filter, to improve the manufacturing efficiency, and to improve the wiring reliability.

Moreover, since a decrease of the resolution of the variable wavelength interference filter can be suppressed, the optical module can accurately measure the intensity of light serving as a measurement subject using the light extracted with high resolution.

Still another aspect of the invention is directed to a spectroscopic analyzer including: the optical module according to the above aspect; and an analysis processor that analyzes optical properties of the light based on the light detected by the detector of the optical module.

Here, examples of the spectroscopic analyzer include an optical measuring instrument that analyzes the chromaticity, brightness, or the like of light entering the optical module based on an electrical signal output from the optical module, a gas detecting device that detects an absorption wavelength of gas to examine the kind of gas, and an optical communication device that acquires data included in light of a specific wavelength from received light.

In the above aspect of the invention, the spectroscopic analyzer includes the optical module according to the above aspect. As described above, since the optical module has high wiring reliability, the spectroscopic analyzer including the optical module also provides high reliability.

Moreover, since the intensity of the test subject light can be accurately measured by the optical module, highly-accurate spectroscopic analysis can be performed using the measured light intensity.

### BRIEF DESCRIPTION OF THE DRAWINGS

The invention will be described with reference to the accompanying drawings, wherein like numbers reference like elements.

FIG. 1 is a diagram illustrating a simplified configuration of a colorimetric device (spectroscopic analyzer) according to a first embodiment of the invention.

FIG. 2 is a plan view illustrating a simplified configuration of a variable wavelength interference filter according to the first embodiment.

FIG. 3 is a cross-sectional view of the variable wavelength interference filter according to the first embodiment.

FIG. 4 is a plan view of the variable wavelength interference filter according to the first embodiment when a fixed substrate is viewed from a movable substrate side.

FIG. 5 is a plan view of the variable wavelength interference filter according to the first embodiment when a movable substrate is viewed from a fixed substrate side.

FIG. 6 is a wiring diagram of an electrostatic actuator according to the first embodiment.

FIG. 7 is a diagram illustrating a wiring structure when the variable wavelength interference filter is incorporated into a colorimetric sensor.

FIG. 8 is a diagram illustrating another example of a wiring structure when the variable wavelength interference filter is incorporated into a colorimetric sensor.

FIG. 9 is a plan view illustrating a simplified configuration of a variable wavelength interference filter according to a second embodiment of the invention.

FIG. 10 is a plan view of the variable wavelength interference filter according to the second embodiment when a fixed substrate is viewed from a movable substrate side.

FIG. 11 is a plan view of the variable wavelength interference filter according to the second embodiment when a movable substrate is viewed from a fixed substrate side.

FIG. 12 is a cross-sectional view of the variable wavelength interference filter according to the second embodiment.

### DESCRIPTION OF EXEMPLARY EMBODIMENTS

### First Embodiment

Hereinafter, the first embodiment of the invention will be described with reference to the drawings.

### 1. Overall Configuration of Colorimetric Device

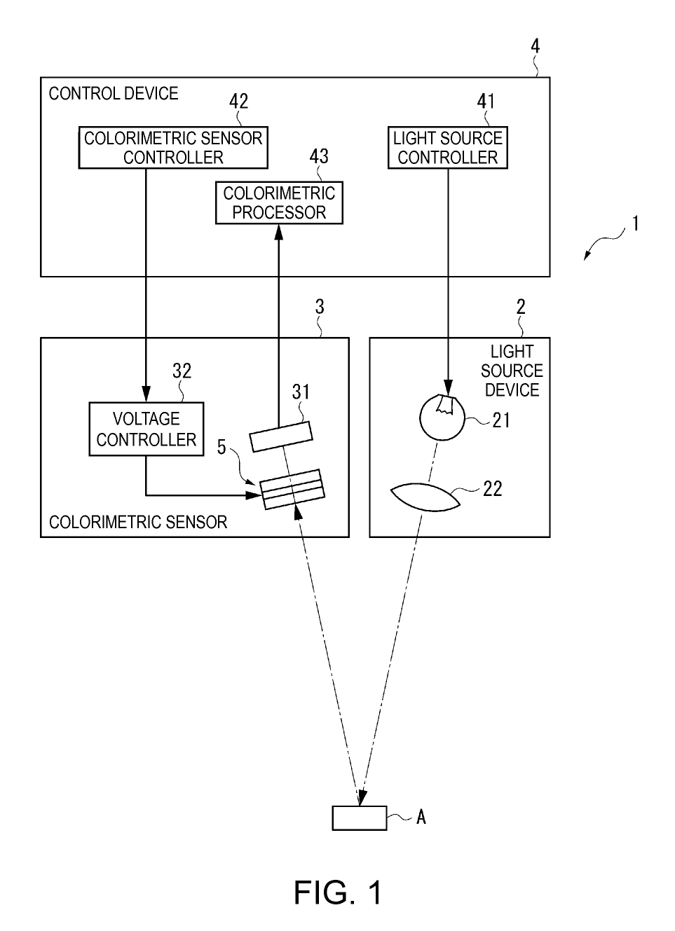

FIG. 1 is a diagram illustrating a simplified configuration of a colorimetric device (spectroscopic analyzer) according to an embodiment of the invention.

The colorimetric device 1 is a spectroscopic analyzer according to the invention, and as shown in FIG. 1, includes a light source device 2 that emits light to a measurement subject A, a colorimetric sensor 3 which is an optical module, and a control device 4 that controls an overall operation of the colorimetric device 1. The colorimetric device 1 is a device in which light emitted from the light source device 2 is reflected by the measurement subject A, the reflected test subject light is received by the colorimetric sensor 3, and the chromaticity of the test subject light, namely the color of the measurement subject A is analyzed and measured based on the detection signal output from the colorimetric sensor 3.

### 2. Configuration of Light Source Device

The light source device 2 includes a light source 21 and a plurality of lenses 22 (only one of which is shown in FIG. 1) and emits white light to the measurement subject A. The plurality of lenses 22 may include a collimator lens. In this case, the light source device 2 collimates the white light emitted from the light source 21 using the collimator lens and emits the collimated light toward the measurement subject A from a projection lens (not shown).

In the present embodiment, although the colorimetric device 1 having the light source device 2 is illustrated, when the measurement subject A is a light emitting member such as a liquid crystal panel, for example, the light source device 2 may not be omitted from the colorimetric device 1.

### 3. Configuration of Colorimetric Sensor

The colorimetric sensor 3 forms the optical module. As shown in FIG. 1, the colorimetric sensor 3 includes a variable wavelength interference filter 5, a detector 31 that receives and detects light having passed through the variable wavelength interference filter 5, and a voltage controller 32 that applies a driving voltage to the variable wavelength interference filter 5. Moreover, the colorimetric sensor 3 includes an incidence optical lens (not shown) which is disposed at a position facing the variable wavelength interference filter 5 so as to guide reflection light (test subject light) reflected by the measurement subject A to the inner side of the colorimetric sensor 3. In the colorimetric sensor 3, light of a predetermined wavelength within the test subject light entering from the incidence optical lens is filtered by the variable wavelength interference filter 5, and the filtered light is received by the detector 31.

The detector 31 includes a plurality of photoelectric conversion elements and generates an electrical signal corresponding to the amount of received light. The detector 31 is connected to the control device 4 and outputs the generated electrical signal to the control device 4 as a reception light signal.

### 3-1. Configuration of Variable Wavelength Interference Filter

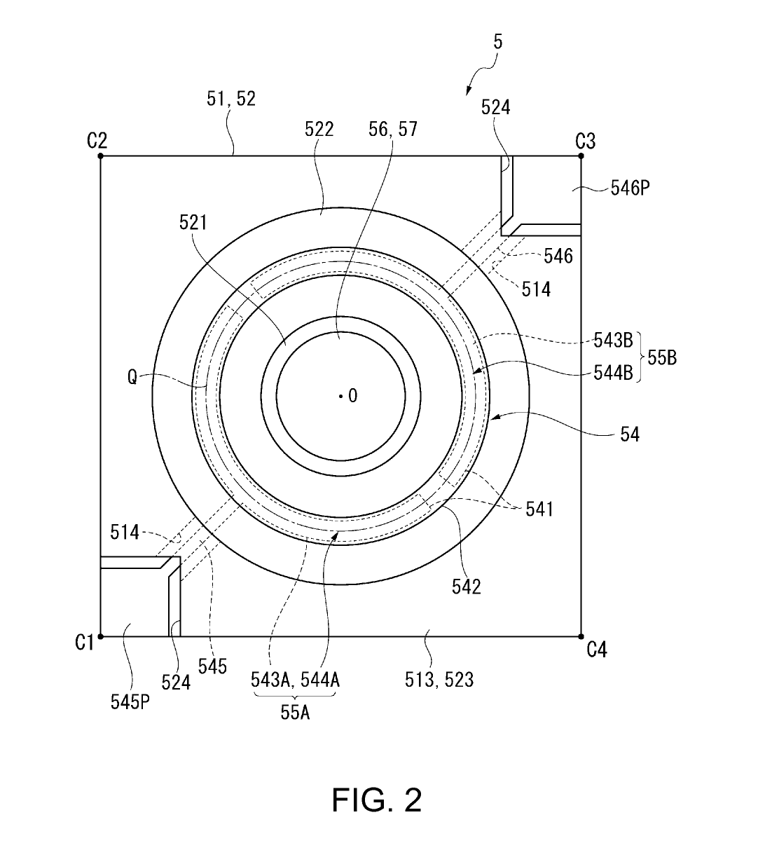

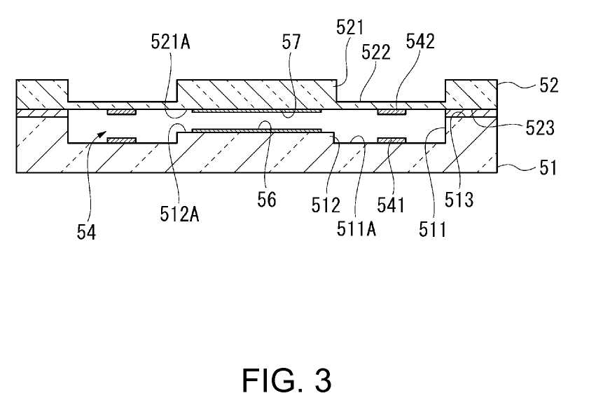

FIG. 2 is a plan view illustrating a simplified configuration of the variable wavelength interference filter 5, and FIG. 3 is a cross-sectional view of the variable wavelength interference filter 5.

As shown in FIG. 2, the variable wavelength interference filter 5 is a planar optical member having a square shape in plan view. As shown in FIG. 3, the variable wavelength interference filter 5 includes a fixed substrate 51 (which is a first substrate) and a movable substrate 52 (which is a second substrate). These two substrates 51 and 52 are each formed, for example, of various kinds of glass such as soda glass, crystalline glass, quartz glass, lead glass, potassium glass, borosilicate glass, or alkali-free glass, crystal, and the like. Moreover, these two substrates 51 and 52 are integrated with each other by bonding portions 513 and 523 which are formed in the vicinity of the outer circumference thereof and which are bonded to each other by surface activated bonding, siloxane bonding using a plasma polymerized film, or the like, for example.

A fixed reflecting film 56 (which forms a first reflecting film) is provided on the fixed substrate 51, and a movable reflecting film 57 (which forms a second reflecting film) is provided on the movable substrate 52. Here, the fixed reflecting film 56 is fixed to a surface of the fixed substrate 51 facing the movable substrate 52, and the movable reflecting film 57 is fixed to a surface of the movable substrate 52 facing the fixed substrate 51. Moreover, the fixed reflecting film 56 and the movable reflecting film 57 are disposed so as to face each other with a gap therebetween.

Furthermore, an electrostatic actuator 54 configured to adjust the dimension of the gap between the fixed reflecting film 56 and the movable reflecting film 57 is provided between the fixed substrate 51 and the movable substrate 52. The electrostatic actuator 54 includes a fixed electrode 541 (serving as a first electrode), which is provided on the fixed substrate 51 side, and a movable electrode 542 (serving as a second electrode), which is provided on the movable substrate 52 side.

### 3-1-1. Configuration of Fixed Substrate

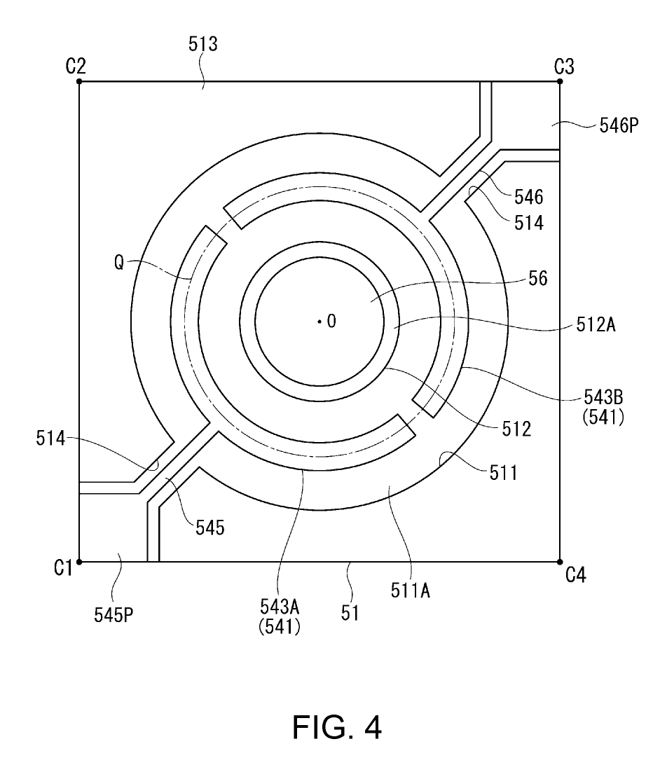

FIG. 4 is a plan view of the variable wavelength interference filter 5 according to the first embodiment when the fixed substrate 51 is viewed from the movable substrate 52 side.

The fixed substrate 51 is formed by processing a glass substrate having a thickness of 500 μm, for example. Specifically, as shown in FIG. 3, an electrode forming groove 511 and a reflecting film fixing portion 512 are formed in the fixed substrate 51 by etching. Since the fixed substrate 51 has a larger thickness dimension than the movable substrate 52, the fixed substrate 51 should not be deformed by the electrostatic attractive force generated when a voltage is applied between the fixed electrode 541 and the movable electrode 542 and internal stress of the fixed electrode 541.

As shown in FIG. 4, the electrode forming groove 511 is formed in a circular shape about the central point of the plane of the fixed substrate 51 in a plan view thereof. The reflecting film fixing portion 512 is formed so as to protrude from the central portion of the electrode forming groove 511 to the movable substrate 52 side in the plan view.

Moreover, a pair of electrode extracting grooves 514 extending from the electrode forming groove 511 to the apexes C₁ and C₃ of the outer circumference of the fixed substrate 51 are provided in the fixed substrate 51.

The fixed electrode 541 is formed in an electrode forming surface 511A which is the bottom portion of the electrode forming groove 511 of the fixed substrate 51.

As shown in FIG. 4, the fixed electrode 541 includes a pair of circular arc-shaped fixed partial electrodes which are disposed on the circumference of an imaginary circle Q having its center at the central point O of the fixed reflecting film 56. The pair of fixed partial electrodes are made up of first and second fixed partial electrodes 543A and 543B (which form first and second partial electrodes).

These fixed partial electrodes 543A and 543B are formed such that the planar shapes in a plan view seen from a substrate thickness direction are identical, and they have an approximately semicircular arc-shape and have the same thickness dimension. The width dimension (the distance between the internal circle and the external circle of the arc) of each of the fixed partial electrodes 543A and 543B is uniform. Moreover, these fixed partial electrodes 543A and 543B are disposed on the circumference of the imaginary circle Q having the center at the central point O of the fixed reflecting film 56 so as to be symmetrical about the central point O in a plan view.

Moreover, the fixed substrate 51 includes a first extraction electrode 545 extending from the first fixed partial electrode 543A and a second extraction electrode 546 extending from the second fixed partial electrode 543B.

The first extraction electrode 545 is formed so as to extend from the outer circumference of the first fixed partial electrode 543A along the electrode extracting groove 514 extended toward the apex C₁ of the fixed substrate 51 in FIG. 4. A first electrode pad 545P which is connected to the voltage controller 32 is provided at a distal end portion of the first extraction electrode 545.

Moreover, the second extraction electrode 546 is formed so as to extend from the outer circumference of the second fixed partial electrode 543B along the electrode extracting groove 514 extended toward the apex C₃ of the fixed substrate 51 in FIG. 4. A second electrode pad 546P which is connected to the voltage controller 32 is provided at a distal end portion of the second extraction electrode 546.

Furthermore, an insulating film (not shown) configured to prevent discharge between the fixed electrode 541 and the movable electrode 542 is formed on these fixed partial electrodes 543A and 543B.

As described above, the reflecting film fixing portion 512 is formed in a cylindrical shape having a smaller diameter than the electrode forming groove 511 on the same axis as the electrode forming groove 511. In the present embodiment, as shown in FIG. 3, although an example in which a reflecting film fixing surface 512A of the reflecting film fixing surface 512 facing the movable substrate 52 is formed to be closer to the movable substrate 52 than the electrode forming surface 511A, the invention is not limited to this. The height positions of the electrode forming surface 511A and the reflecting film fixing surface 512A are appropriately set in accordance with the gap between the fixed reflecting film 56 fixed to the reflecting film fixing surface 512A and the movable reflecting film 57 formed on the movable substrate 52, the gap between the fixed electrode 541 and the movable electrode 542, and the thicknesses of the fixed reflecting film 56 and the movable reflecting film 57. Therefore, for example, the electrode forming surface 511A and the reflecting film fixing surface 512A may be formed on the same surface, and a reflecting film fixing groove on the columnar groove may be formed in the central portion of the electrode forming surface 511A, and the reflecting film fixing surface 512A may be formed on the bottom surface of the reflecting film fixing groove.

The fixed reflecting film 56 having a circular shape is fixed to the reflecting film fixing surface 512A. The fixed reflecting film 56 may be formed of a single-layer metal film or a dielectric multi-layer film and may be formed of a dielectric multi-layer film on which an Ag alloy is formed. An Ag alloy single-layer film, for example, can be used as the single-layer metal film, and a dielectric multi-layer film in which TiO₂ is used as a high refractive index layer and SiO₂ is used as a low refractive index layer, for example, can be used as the dielectric multi-layer film.

An anti-reflection film (not shown) is formed on a surface of the fixed substrate 51 opposite to the surface facing the movable substrate 52 at a position corresponding to the fixed reflecting film 56. The anti-reflection film is formed by alternately stacking a low refractive index film and a high refractive index film and decreases reflectance of visible rays on the surface of the fixed substrate 51 and increases transmittance.

### 3-1-2. Configuration of Movable Substrate

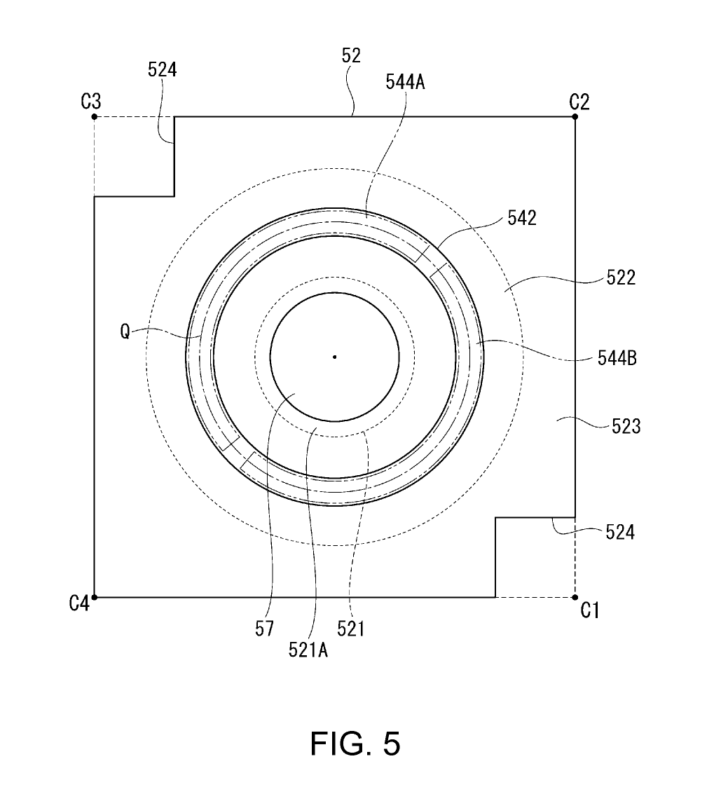

FIG. 5 is a plan view of the variable wavelength interference filter 5 according to the first embodiment when the movable substrate 52 is viewed from the fixed substrate 51 side.

The movable substrate 52 is formed by processing a glass substrate having a thickness of 200 μm, for example, by etching.

Specifically, the movable substrate 52 includes a movable portion 521 having a circular shape about the substrate central point in the plan view as shown in FIGS. 2 and 5 and a holding portion 522 which is on the same axis as the movable portion 521 and holds the movable portion 521.

Moreover, as shown in FIGS. 2 and 5, the movable substrate 52 includes notches 524 at positions facing the first and second electrode pads 545P and 546P. In such a configuration, the electrode pads 545P and 546P are exposed to the surface of the variable wavelength interference filter 5 seen from the movable substrate 52 side.

The movable portion 521 has a larger thickness than the holding portion 522, and for example, in the present embodiment, has the same thickness of 200 μm as the thickness of the movable substrate 52. Moreover, the movable portion 521 includes a movable surface 521A that is parallel to the reflecting film fixing portion 512, and the movable reflecting film 57 facing the fixed reflecting film 56 with a gap therebetween is fixed to the movable surface 521A.

Here, as the movable reflecting film 57, a reflecting film having the same configuration as the fixed reflecting film 56 described above is used.

Furthermore, an anti-reflection film (not shown) is formed on a surface of the movable portion 521 on the opposite side to the movable surface 521A at a position corresponding to the movable reflecting film 57. The anti-reflection film has the same configuration as the anti-reflection film formed on the fixed substrate 51 and is formed by alternately stacking a low refractive index film and a high refractive index film.

The holding portion 522 is a diaphragm surrounding the periphery of the movable portion 521 and has a thickness of 50 μm, for example, and smaller rigidity in the thickness direction than the movable portion 521.

Therefore, the holding portion 522 is more easily deformed than the movable portion 521 and can be deformed toward the fixed substrate 51 by a very small electrostatic attractive force. In this case, since the movable portion 521 has a larger thickness and larger rigidity than the holding portion 522, even when a force that deforms the movable substrate 52 is applied by an electrostatic attractive force, the movable portion 521 is hardly deformed, and deformation of the movable reflecting film 57 formed on the movable portion 521 can be prevented.

The movable electrode 542 (which forms the second electrode) which faces the fixed electrode 541 with a gap of about 1 μm disposed therebetween in the initial state is formed on the surface of the holding portion 522 facing the fixed substrate 51.

As shown in FIG. 5, the movable electrode 542 is formed in a ring shape along the imaginary circle Q so that the width which is the difference between the internal diameter dimension and the external dimension is uniform along the circumferential direction of the imaginary circle Q. Here, the movable electrode 542 is formed in a ring shape which includes a first facing region 544A that overlaps the first fixed partial electrode 543A and a second facing region 544B that overlaps the second fixed partial electrode 543B in the plan view seen from the substrate thickness direction as shown in FIG. 2. Moreover, the first fixed partial electrode 543A and the first facing region 544A of the movable electrode 542 form a first partial actuator 55A, and the second fixed partial electrode 543B and the second facing region 544B of the movable electrode 542 form a second partial actuator 55B.

### 3-1-3. Configuration of Electrostatic Actuator

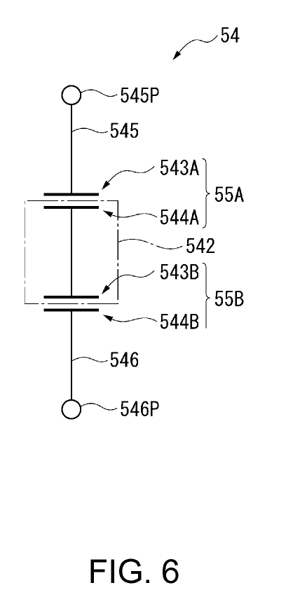

FIG. 6 is a wiring diagram of the electrostatic actuator 54 according to the first embodiment.

As described above, the electrostatic actuator 54 includes the first partial actuator 55A which is made up of the first fixed partial electrode 543A and the first facing region 544A of the movable electrode 542 and the second partial actuator 55B which is made up of the second fixed partial electrode 543B and the second facing region 544B of the movable electrode 542.

In such an electrostatic actuator 54, when a driving voltage V is applied between the first electrode pad 545P of the first extraction electrode 545 and the second electrode pad 546P of the second extraction electrode 546, divided voltages V₁ and V₂ corresponding to capacitance reactance are applied to the respective partial actuators 55A and 55B.

Moreover, the respective partial actuators 55A and 55B are formed in the same shape and disposed at the same angular interval (180°) on the imaginary circle Q in the plan view of the variable wavelength interference filter 5 seen from the substrate thickness direction. Thus, when the distances between electrodes (inter-electrode gaps) of the respective partial actuators 55A and 55B are d₁ and d₂, the area of the first and second fixed partial electrodes 543A and 543B and the first and second facing regions 544A and 544B is S, and permittivity is ∈, the electrostatic capacitances C₁ and C₂ of the respective partial actuators 55A and 55B are expressed by Expressions (1) and (2) below.

C₁=∈S/d₁ (1)

C₂=∈S/d₂ (2)

Here, since the respective partial actuators 55A and 55B are electrically connected in series, the quantities Q of electric charges held by these partial actuators 55A and 55B are the same values, and Expression (3) below is satisfied.

Q=C₁V₁=C₂V₂ (3)

On the other hand, the electrostatic attractive forces F₁ and F₂ acting on the respective partial actuators 55A and 55B are expressed as products E₁Q and E₂Q between the electric fields E₁ and E₂ between the electrodes of the respective partial actuators 55A and 55B and the quantity Q of electric charges held by the respective partial actuators 55A and 55B.

Thus, by substituting Expressions (1) to (3), the electrostatic attractive forces F₁ and F₂ can be expressed as Expressions (4) and (5) below.

F₁=E₁Q=Q²/∈S (4)

F₂=E₂Q=Q²/∈S (5)

That is, as shown in Expressions (4) and (5), the electrostatic attractive forces F₁ and F₂ acting on the respective partial actuators 55A and 55B have the same value regardless of the values of inter-partial electrode gaps d₁ and d₂.

Thus, for example, the initial values of the inter-electrode gaps d₁ and d₂ have a very small difference that does not affect the measurement accuracy, for example. Even when a voltage is applied to the electrostatic actuator 54, it is possible to uniformly deform the holding portion 522 without increasing the difference between the inter-electrode gaps d₁ and d₂.

### 3-1-4. Wiring to Variable Wavelength Interference Filter

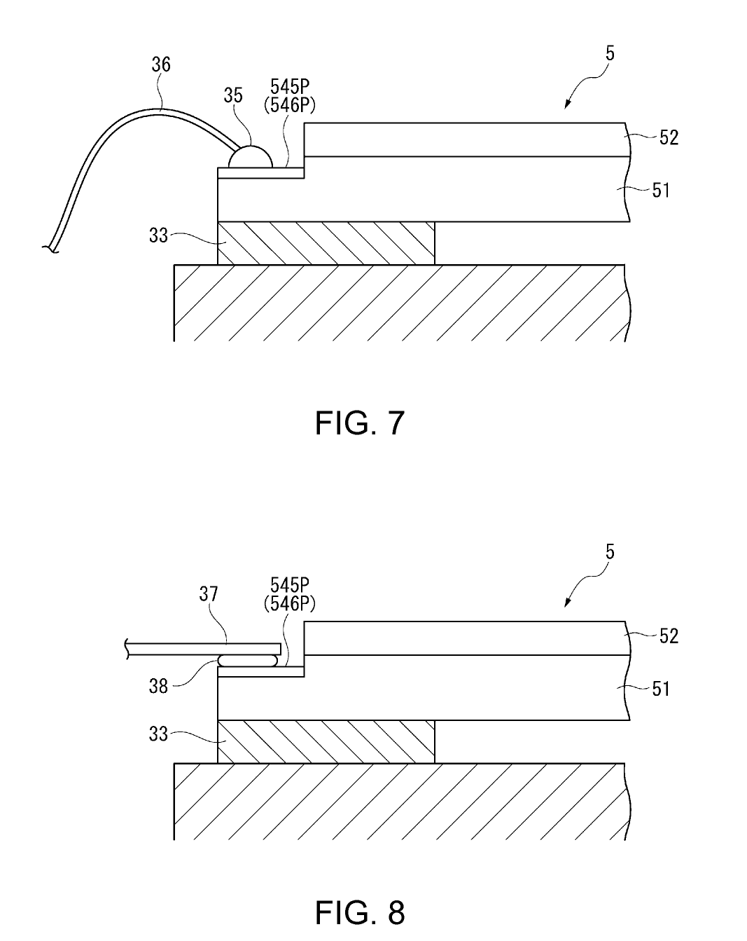

FIG. 7 is a diagram illustrating a wiring structure when the variable wavelength interference filter 5 is incorporated into the colorimetric sensor 3. FIG. 8 is a diagram illustrating another example of a wiring structure when the variable wavelength interference filter 5 is incorporated into the colorimetric sensor 3.

When incorporating the variable wavelength interference filter 5 into the colorimetric sensor 3, in general, the variable wavelength interference filter 5 is directly fixed to a filter fixing substrate provided to the colorimetric sensor 3, or the variable wavelength interference filter 5 is held by a case and the case is fixed to the filter fixing substrate.

When connecting the electrode pads 545P and 546P of the variable wavelength interference filter 5 to the voltage controller 32 of the colorimetric sensor 3, wirings are laid out in a state where the variable wavelength interference filter 5 is fixed to a fixing portion 33.

In this case, as a wiring to the variable wavelength interference filter 5, a conductive member 35 such as a molten Ag paste is provided on the electrode pads 545P and 546P, and a lead wire 36 is connected from the movable substrate 52 side of the variable wavelength interference filter 5 before the conductive member 35 solidifies. In this case, the wiring operation can be easily realized by connecting the lead wire 36 from the movable substrate 52 side of the variable wavelength interference filter 5.

Moreover, as a wiring to the variable wavelength interference filter 5, a flexible printed circuit (FPC) 37, for example, may be connected through an anisotropic conductive layer 38 such as an anisotropic conductive film (ACF) or an anisotropic conductive paste (ACP). In this case, the anisotropic conductive layer 38 is formed on the electrode pads 545P and 546P, and after the FPC 37 is placed thereon, the FPC 37 is pressed from the movable substrate 52 side of the variable wavelength interference filter 5. In this case, since no stress is applied to the movable substrate 52, detachment between the fixed substrate 51 and the movable substrate 52, deformation of the movable substrate 52, and the like should not occur, and the performance of the variable wavelength interference filter 5 can be maintained.

### 3-2. Configuration of Voltage Controller

The voltage controller 32 controls a voltage applied to the electrostatic actuator 54 based on a control signal input from the control device 4.

### 4. Configuration of Control Device

The control device 4 controls an overall operation of the colorimetric device 1.

As the control device 4, a general-purpose personal computer, a mobile information terminal, a colorimetric dedicated computer, and the like can be used, for example.

As shown in FIG. 1, the control device 4 includes a light source controller 41, a colorimetric sensor controller 42, and a colorimetric processor 43 (constituting the analysis processor).

The light source controller 41 is connected to the light source device 2. Moreover, the light source controller 41 outputs a predetermined control signal to the light source device 2 based on a user setting input, for example, and emits white light of predetermined brightness from the light source device 2.

The colorimetric sensor controller 42 is connected to the colorimetric sensor 3. Moreover, the colorimetric sensor controller 42 sets the wavelength of light to be received by the colorimetric sensor 3 based on the user setting input, for example, and outputs a control signal to the colorimetric sensor 3 so as to detect the amount of the received light of the wavelength. In this way, the voltage controller 32 of the colorimetric sensor 3 sets a voltage to be applied to the electrostatic actuator 54 based on the control signal so that light of the wavelength desired by the user can pass therethrough.

The colorimetric processor 43 analyzes the chromaticity of the measurement subject A based on the amount of the received light detected by the detector 31.

### 5. Operation and Effect of First Embodiment

As described above, the variable wavelength interference filter 5 of the above embodiment is formed in a ring shape in which the fixed electrode 541 is made up of the first and second fixed partial electrodes 543A and 543B electrically isolated from each other, and the movable electrode 542 includes the first facing region 544A facing the first fixed partial electrode 543A and the second facing region 544B facing the second fixed partial electrode 543B. Moreover, the first extraction electrode 545 is formed in the first fixed partial electrode 543A, and the second extraction electrode 546 is formed in the second fixed partial electrode 543B.

In such a configuration, by applying a driving voltage between the first electrode pad 545P of the first extraction electrode 545 and the second electrode pad 546P of the second extraction electrode 546, it is possible to drive the first partial actuator 55A which is made up of the first fixed partial electrode 543A and the first facing region 544A of the movable electrode 542 and the second partial actuator 55B which is made up of the second fixed partial electrode 543B and the second facing region 544B of the movable electrode 542.

The first extraction electrode 545 and the second extraction electrode 546 are formed on the fixed substrate 51 and are connected to the first and second electrode pads 545P and 546P formed on the outer circumference of the fixed substrate 51.

Thus, when connecting the lead wire 36 through the conductive member 35 such as an Ag paste or connecting the FPC 37 through the anisotropic conductive layer 38 in order to incorporate the variable wavelength interference filter 5 into the colorimetric sensor 3, the wiring operation can be easily performed from the movable substrate 52 side of the variable wavelength interference filter 5. Moreover, even when stress is applied to the fixed substrate 51 fixed to the fixing portion 33 due to the wiring, since no stress is applied to the movable substrate 52, detachment between the fixed substrate 51 and the movable substrate 52 and tilt of the movable substrate 52 should not occur, and a decrease of the performance of the variable wavelength interference filter can be prevented. Moreover, since wirings can be reliably laid out to the respective electrode pads 545P and 546P of the fixed substrate 51, wiring reliability is improved, and the reliability of the colorimetric sensor 3 and the colorimetric device 1 can be improved.

Moreover, the notches 524 are formed in the movable substrate 52 at the positions corresponding to the electrode pads 545P and 546P. Thus, the movable substrate 52 does not become an obstacle during the wiring operation. Moreover, wirings can be laid out without applying stress to the movable substrate 52.

Moreover, the width dimensions of the respective partial actuators 55A and 55B are uniform in a direction orthogonal to the circumferential direction of the imaginary circle Q and the substrate thickness direction. Thus, the electrostatic attractive force of the respective partial actuators 55A and 55B does not become uneven along the circumferential direction, and the movable portion 521 can be displaced with high accuracy.

The first and second fixed partial electrodes 543A and 543B of the fixed electrode 541 have the same shape in a plan view thereof and are disposed on the circumference of the imaginary circle Q so as to be symmetrical about the central point O. Moreover, the first partial actuator 55A made up of the first fixed partial electrode 543A and the first facing region 544A and the second partial actuator 55B made up of the second fixed partial electrode 543B and the second facing region 544B are electrically connected in series.

Therefore, when a driving voltage is applied to the electrostatic actuator 54, an electrostatic attractive force of the same magnitude acts on the respective partial actuators 55A and 55B. Thus, even when the gap between the fixed reflecting film 56 and the movable reflecting film 57 is changed, it is possible to maintain the parallelism between the fixed reflecting film 56 and the movable reflecting film 57 and to suppress a decrease of resolution.

Furthermore, the movable electrode 542 is formed on the holding portion 522 of the movable substrate 52 in a ring shape along the circumference of the imaginary circle Q. That is, the movable electrode 542 is formed in a shape such that it is symmetrical about the central point of the movable portion 521. Moreover, the movable substrate 52 does not require an extraction electrode or the like extending from the movable electrode 542, and film stress or the like due to the extraction electrode does not occur.

Therefore, the film stress of the movable electrode 542 acting on the holding portion 522 becomes uniform, and it is possible to maintain stress balance of the holding portion 522 to be uniform and to suppress tilting of the movable portion 521. Thus, it is possible to maintain a uniform gap dimension between the reflecting films 56 and 57 and to maintain the resolution of the variable wavelength interference filter 5 with high accuracy.

### Second Embodiment

Next, the second embodiment of the invention will be described with reference to the drawings.

The second embodiment is one in which the variable wavelength interference filter 5 of the colorimetric device 1 of the first embodiment is modified. Thus, a variable wavelength interference filter 5A according to the second embodiment will be described hereinbelow.

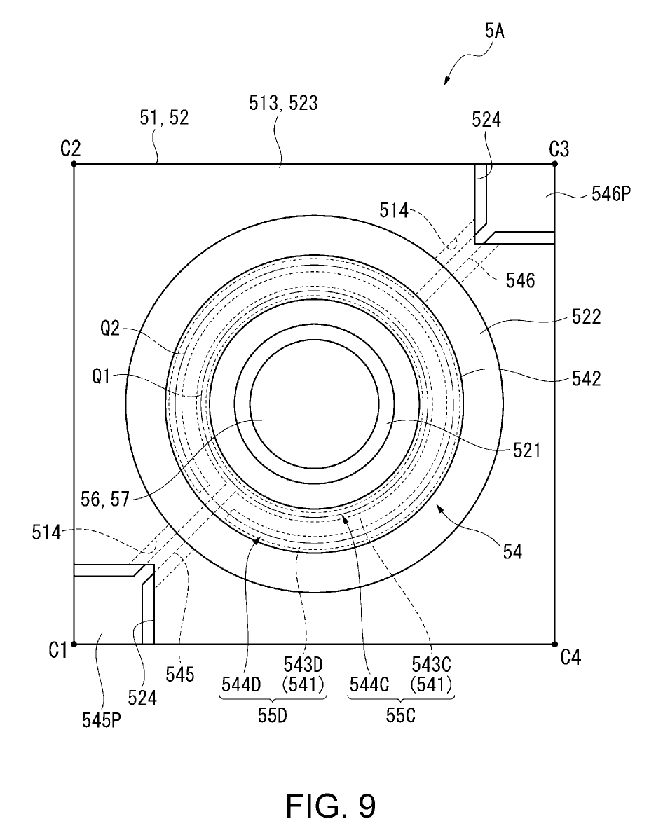

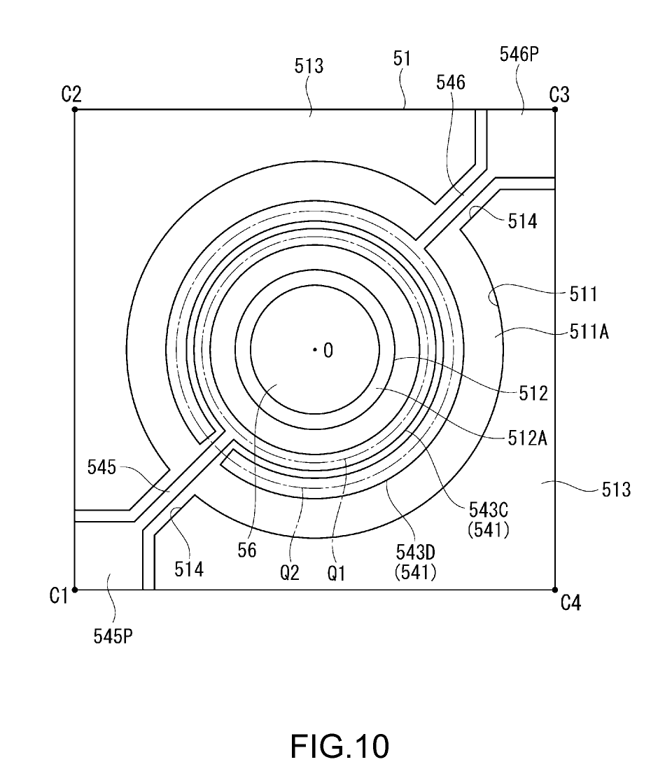

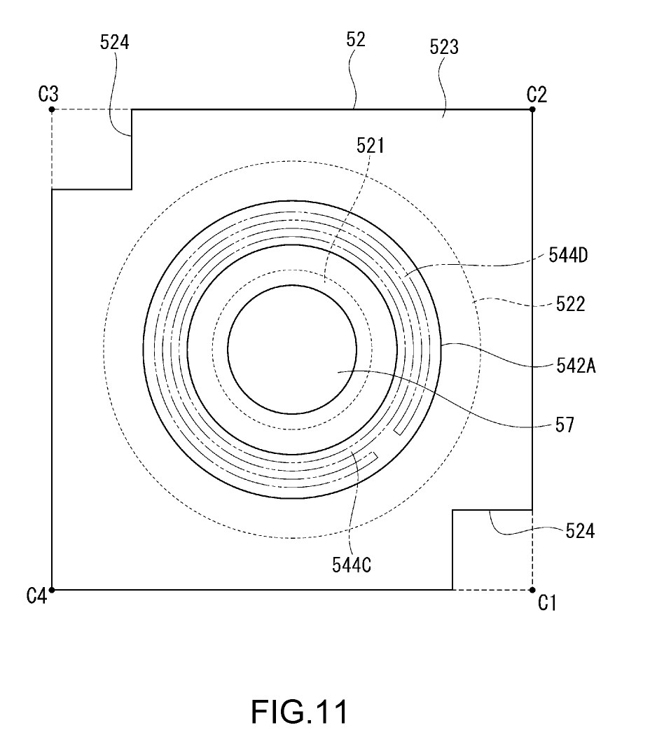

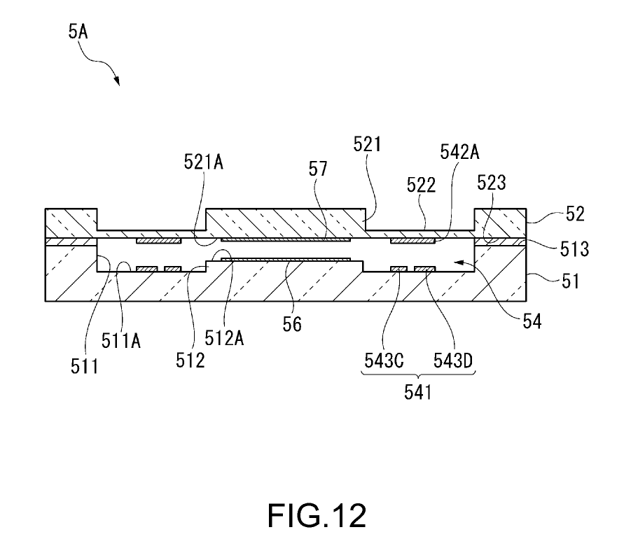

FIG. 9 is a plan view illustrating a simplified configuration of the variable wavelength interference filter 5A according to the second embodiment. FIG. 10 is a plan view of the variable wavelength interference filter 5A when the fixed substrate 51 is viewed from the movable substrate 52 side. FIG. 11 is a plan view of the variable wavelength interference filter 5A when the movable substrate 52 is viewed from the fixed substrate 51 side. FIG. 12 is a cross-sectional view of the variable wavelength interference filter 5A. The same constituent elements as the first embodiment described above will be denoted by the same reference numerals, and a description thereof will not be provided.

In the variable wavelength interference filter 5 according to the first embodiment described above, an example in which two partial actuators 55A and 55B are disposed along one imaginary circle Q is illustrated. In contrast, in the second embodiment, partial actuators 55C and 55D are disposed along two imaginary circles Q1 and Q2 which are concentric about the central point O. The configuration will be described in detail below.

### 6. Configuration of Variable Wavelength Interference Filter

### 6-1. Configuration of Fixed Substrate

Similarly to the first embodiment, the electrode forming groove 511 and the reflecting film fixing portion 512 are formed in the fixed substrate 51 of the variable wavelength interference filter 5A by etching.

A fixed electrode 541 including first and second fixed partial electrodes 543C and 543D is formed in the electrode forming groove 511. Here, as shown in FIGS. 9 and 10, the first fixed partial electrode 543C is formed in a ring shape along an imaginary circle Q1 having the center at the central point O of the fixed reflecting film 56, and the width dimension thereof is uniform. Moreover, a first extraction electrode 545 extending from the first fixed partial electrode 543C toward the apex C₁ is provided to the fixed substrate 51.

On the other hand, the second fixed partial electrode 543D is provided on the outer circumference side of the first fixed partial electrode 543C and formed in a C-shape along an imaginary circle Q2 having a larger diameter than the imaginary circle Q1. The second fixed partial electrode 543D is open at a position corresponding to the first extraction electrode 545, and the width dimension thereof is uniform. Moreover, a second extraction electrode 546 extending from the second fixed partial electrode 543D toward the apex C₃ is provided to the fixed substrate 51.

Since the reflecting film fixing portion 512 and the fixed reflecting film 56 have the same configuration as that of the first embodiment, a description thereof will not be provided.

### 6-2. Configuration of Movable Substrate

Similarly to the first embodiment, the movable substrate 52 of the variable wavelength interference filter 5A includes the movable portion 521 formed by etching and the holding portion 522.

Moreover, as shown in FIGS. 9 and 11, the movable substrate 52 of the variable wavelength interference filter 5A includes notches 524 at the positions corresponding to the electrode pads 545P and 546P of the fixed substrate 51. With these notches 524, the electrode pads 545P and 546P are exposed to the surface of the variable wavelength interference filter 5A close to the movable substrate 52.

Since the movable portion 521, the holding portion 522, and the movable reflecting film 57 have the same configuration as that of the first embodiment, a description thereof will not be provided.

As shown in FIGS. 9, 11, and 12, an annular movable electrode 542A which has a uniform width dimension along the circumferential direction and has a larger width dimension in plan view than the first and second fixed partial electrodes 543C and 543D, and which covers a first facing region 544C facing the first fixed partial electrode 543C and a second facing region 544D facing the second fixed partial electrode 543D is provided to the movable substrate 52.

In such a variable wavelength interference filter 5A, the first fixed partial electrode 543C and the first facing region 544C of the movable electrode 542A form a ring-shaped partial actuator 55C having a uniform width dimension. Moreover, the second fixed partial electrode 543D and the second facing region 544D of the movable electrode 542A form a C-shaped partial actuator 55D having a uniform width dimension.

### 7. Operation and Effect of Second Embodiment

The variable wavelength interference filter 5A of the second embodiment provides the same effects as the variable wavelength interference filter 5 of the first embodiment.

That is, by applying a driving voltage between the first electrode pad 545P of the first extraction electrode 545 and the second electrode pad 546P of the second extraction electrode 546, it is possible to drive the partial actuators 55C and 55D.

Moreover, since the first and second electrode pads 545P and 546P are formed on the fixed substrate 51, the wiring operation can be easily performed from the movable substrate 52 side of the variable wavelength interference filter 5A when incorporating the variable wavelength interference filter 5A into the colorimetric sensor 3. Moreover, since no stress is applied to the movable substrate 52 during the wiring operation, detachment between the fixed substrate 51 and the movable substrate 52 and tilting of the movable substrate 52 should not occur, and a decrease of the performance of the variable wavelength interference filter 5A can be prevented. Moreover, since wirings can be reliably laid out to the respective electrode pads 545P and 546P of the fixed substrate 51, wiring reliability is improved, and the reliability of the colorimetric sensor 3 and the colorimetric device 1 can be improved.

Moreover, it is possible to generate a uniform electrostatic attractive force over the entire circumference of the imaginary circle Q1 in the first partial actuator 55C. Furthermore, it is possible to generate a uniform electrostatic attractive force over the entire circumference of the imaginary circle Q2 in the second partial actuator 55D. Therefore, it is possible to reduce unevenness of the electrostatic attractive force and prevent tilting of the movable portion 521.

### Other Embodiment

The invention is not limited to the embodiments described above, but rather the invention includes modifications, improvements, and the like within a range where the object of the invention can be accomplished.

For example, in the first and second embodiments, although the diaphragm-shaped holding portion 522 has been illustrated, a holding portion having a plurality of beam structures provided at symmetrical positions about the center of a movable portion may be provided.

Moreover, in the first and second embodiments, although one electrostatic actuator 54 has been provided, a plurality of electrostatic actuators may be connected in parallel.

Moreover, although the movable electrode 542 has been provided on the holding portion 522, the movable electrode 542 may be provided on the movable portion 521, for example. In this case, it is possible to decrease the influence of the internal stress of the movable electrode 542 and to prevent deformation of the holding portion 522.

Furthermore, in the first and second embodiments, although an example in which the movable portion 521 is provided to the movable substrate 52 which is the second substrate, and the movable portion 521 of the movable substrate 52 is displaced toward the fixed substrate 51 side has been illustrated as the variable wavelength interference filters 5 and 5A, the invention is not limited to this. For example, the movable portion may also be provided to the fixed substrate 51, and the movable portion may be displaceable toward the movable substrate 52 side.

In the embodiments described above, although the colorimetric sensor 3 is illustrated as an example of the optical module, and the colorimetric device 1 is illustrated as an example of the spectroscopic analyzer, the invention is not limited to this.

For example, the optical module according to the invention may be used as a gas detecting module that detects an absorption wavelength unique to gas by receiving light extracted by the variable wavelength interference filter 5 using a light receiving element. The spectroscopic analyzer according to the invention may be used as a gas detecting device that determines the kind of gas from the absorption wavelength detected by the gas detecting module.

Moreover, for example, the optical module may be used as an optical communication module that extracts light of a desired wavelength from light transmitted through an optical transmission medium such as an optical fiber, for example. Moreover, the spectroscopic analyzer may be used as an optical communication device that decodes data from the light extracted from the optical communication module to thereby extract data transmitted via light.

In addition to this, the specific structure and order when implementing the invention may be appropriately changed to other structure or the like within a range where the object of the invention can be attained.

The entire disclosure of Japanese Patent Application No. 2011-010062 filed Jan. 20, 2011 is expressly incorporated by reference herein.

What is claimed is:

1. A variable wavelength interference filter comprising:
a first substrate;
a second substrate facing the first substrate;
a first reflecting film formed on the first substrate;
a second reflecting film formed on the second substrate so as to face the first reflecting film with a gap therebetween; and
an electrostatic actuator including a first electrode formed on the first substrate and a second electrode formed on the second substrate so as to face the first electrode,
wherein the second substrate includes:
a movable portion formed in a circular shape in a plan view of the first and second substrates, and the second reflecting film is formed on the movable portion, and
a holding portion that holds the movable portion so as to be movable toward and away from the first substrate,
wherein the first electrode includes a first partial electrode and a second partial electrode which are formed along an imaginary circle having a center at a central point of the movable portion in the plan view,
wherein a first extraction electrode extending from the first partial electrode toward an outer circumference of the first substrate and a second extraction electrode extending from the second partial electrode toward the outer circumference of the first substrate are formed on the first substrate,
wherein the second electrode includes a first facing region overlapping the first partial electrode and a second facing region overlapping the second partial electrode in the plan view and has a ring shape having a center at the central point of the movable portion,
wherein a first partial actuator constituted by the first partial electrode and the first facing region of the second electrode has a uniform width dimension along the imaginary circle in the plan view, and
wherein a second partial actuator constituted by the second partial electrode and the second facing region of the second electrode has a uniform width dimension along the imaginary circle in the plan view.

2. The variable wavelength interference filter according to claim 1,
wherein the first partial electrode has an annular shape along a first imaginary circle, and
wherein the second partial electrode has a circular arc shape along a second imaginary circle having a larger diameter than the first imaginary circle.

3. The variable wavelength interference filter according to claim 1,
wherein the first partial electrode has a circular arc shape along a first imaginary circle, and
wherein the second partial electrode has a circular arc shape along the first imaginary circle and is formed in the same shape as the first partial electrode in the plan view, and the first and second partial electrodes are formed at positions symmetrical about the central point of the movable portion.

4. An optical module comprising:
the variable wavelength interference filter according to claim 1; and
a detector that detects light extracted by the variable wavelength interference filter.

5. A spectroscopic analyzer comprising:
the optical module according to claim 4;
an analysis processor that analyzes optical properties based on the light detected by the detector of the optical module.

6. An analyzer comprising:
the optical module according to claim 4;
an analysis processor that analyzes optical properties based on the light detected by the detector of the optical module.

7. A variable wavelength interference filter comprising:
a first substrate;
a second substrate facing the first substrate;
a first reflecting film formed on the first substrate;
a second reflecting film formed on the second substrate so as to face the first reflecting film with a gap therebetween; and
a first electrode formed on the first substrate, and a second electrode formed on the second substrate so as to face the first electrode,
wherein the second substrate includes:
a movable portion formed in a circular shape in a plan view of the first and second substrates, and the second reflecting film is formed on the movable portion, and
a holding portion that holds the movable portion so as to be movable toward and away from the first substrate,
wherein the first electrode includes a first partial electrode and a second partial electrode which are formed along an imaginary circle having a center at a central point of the movable portion in the plan view,
wherein a first extraction electrode extending from the first partial electrode toward an outer circumference of the first substrate and a second extraction electrode extending from the second partial electrode toward the outer circumference of the first substrate are formed on the first substrate,
wherein the second electrode includes a first facing region overlapping the first partial electrode and a second facing region overlapping the second partial electrode in the plan view and has a ring shape having a center at the central point of the movable portion,
wherein a first partial actuator constituted by the first partial electrode and the first facing region of the second electrode has a uniform width dimension along the imaginary circle in the plan view, and
wherein a second partial actuator constituted by the second partial electrode and the second facing region of the second electrode has a uniform width dimension along the imaginary circle in the plan view.

8. A variable wavelength interference filter comprising:
a first electrode and a second electrode facing the first electrode; and
a movable portion on which a reflecting film is formed,
wherein the first electrode includes:
a first partial electrode and a second partial electrode formed along an imaginary circle having a center at a central point of the movable portion in a plan view of the movable portion, and
a first extraction electrode extending from the first partial electrode toward an outer circumference and a second extraction electrode extending from the second partial electrode toward the outer circumference,
wherein the second electrode includes a first facing region overlapping the first partial electrode and a second facing region overlapping the second partial electrode in the plan view and has a ring shape having a center at the central point of the movable portion,
wherein a first partial actuator constituted by the first partial electrode and a facing region of the second electrode has a uniform width dimension along the imaginary circle in the plan view, and
wherein a second partial actuator constituted by the second partial electrode and a facing region of the second electrode has a uniform width dimension along the imaginary circle in the plan view.
